(19) United States
(12) Patent Application Publication
(10) Pub. No.: US 2025/0300442 A1
(43) Pub. Date: Sep. 25, 2025

(54) RETRACTABLE POWER CABLE

(71) Applicant: Apple Inc., Cupertino, CA (US)

(72) Inventors: Trevor J Ness, Santa Cruz, CA (US); Linda Y Dunn, Sunnyvale, CA (US)

(21) Appl. No.: 18/868,872

(22) PCT Filed: Jun. 20, 2023
(86) PCT No.: PCT/US2023/068710

§ 371 Date: Nov. 25, 2024

Related U.S. Application Data
(60) Provisional application No. 63/367,466, filed on Jun. 30, 2022.

(51) Int. Cl. H02G 11/02

(52) U.S. Cl. CPC H02G 11/02

(57) ABSTRACT

A head-mountable device assembly can include a display, a power unit, a cable electrically connecting the display and the power unit, and a retraction device configured to collect the cable.

### CROSS-REFERENCE TO RELATED APPLICATION(S)

This claims priority to U.S. Provisional Patent Application No. 63/367,466, filed 30 Jun. 2022, and entitled “RETRACTABLE POWER CABLE,” the entire disclosure of which is hereby incorporated by reference.

### FIELD

The described embodiments relate generally to head-mountable devices. More particularly, the present embodiments relate to a retraction device for retracting a power cable of a head-mountable assembly.

### BACKGROUND

A primary challenge when developing head-mountable displays, particularly head-mountable displays that have small form factors, is achieving a suitable battery life while still maintaining functionality and a socially acceptable shape and size. Performing the necessary computing functions and extended use of the head-mountable display may deplete the battery life more quickly than desirable. Given the power needs of modern head-mountable displays and current battery technology, a user may be required to remove the head-mountable display to charge the battery several times a day, often interrupting use, and causing inconvenience to the user. Accordingly, there is a need for a head-mountable assembly including an auxiliary or supplementary battery that can supplement a primary battery of the device. However, including an auxiliary battery comes with the additional challenge of cable management. Thus, there is a need for a head-mountable assembly having a cable management system, such as a retraction device to control the length of the cable.

### SUMMARY

According to some aspects of the present disclosure, a head-mountable device assembly can include a display, a power unit, a cable electrically connecting the display and the power unit, and a retraction device configured to collect the cable.

In some examples, the power unit can include a housing and a supplemental battery. The retraction device can be disposed within the housing, and the cable can be collectable within the housing. The retraction device can include a torsion spring. The retraction device can include a cable lock. The retraction device can include a motor that actuates the retraction device in response to an input.

In some examples, the head-mountable device assembly can include a sensor, and a processor to actuate the retraction device in response to a signal from the sensor. The processor can operate the retraction device based on an activity of the display. The display can include a user interface to control the retraction device. An encoder can determine an uncollected length of the cable. The retraction device can be integrated into the power unit.

According to some aspects, an electronic accessory for a head-mountable device can include a housing, a battery disposed within the housing, and a cable retraction system disposed within the housing.

In some examples, the battery can be removable from the housing. The cable retraction system can include a motor electrically connected to the battery, and a spool connected to the motor and the cable. The cable can have a length between 50 mm and 2 meters. The retraction device can impart a pull force of between approximately 30 grams to approximately 300 grams on the cable.

According to some aspects, a head-mountable device can include a display, a cable electrically connectable to the head-mountable device an auxiliary battery, and a retraction device configured to collect the cable, the retraction device including a spool rotatable to collect the cable, a motor to rotate the spool, and a processor to operate the motor based on an activity of the display.

In some examples, the retraction device can retract the cable in response to detecting slack in the cable. The retraction device can provide a constant pull force on the cable. The retraction device can include a torsion spring. The head-mountable device can include an encoder to determine an uncollected length of the cable.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 shows a schematic block diagram of an HMD assembly.

FIG. 2 shows a side view of an HMD assembly having an auxiliary battery.

FIG. 3 shows a side view of an HMD assembly having a retraction device.

FIG. 4 shows a cross-sectional view of an HMD accessory.

FIG. 5 shows a cross-sectional view of an HMD accessory.

FIG. 6 shows a front view of an HMD accessory case.

FIG. 7 shows an exploded view of an example retraction device.

FIG. 8 shows a cross-sectional view of a retraction device having a locking mechanism.

FIG. 9 shows a side view of an HMD assembly having an accessory mount.

### DETAILED DESCRIPTION

The following disclosure relates to a cable management system. More specifically, this disclosure relates to a retraction device for adjust a power cable of a head-mountable device (HMD).

Given the power needs of modern HMDs and current battery technology, a user may desire an auxiliary or supplementary battery that can supplement a primary battery of the HMD. However, including an auxiliary battery comes with the additional challenge of cable management. Excessive slack in the power cable can be inconvenient and bothersome. This is particularly the case when the user is mobile while wearing the HMD. Further, in some situations the auxiliary battery will not be located on the person's body, increasing the need for a cable management system. The cable management system can dynamically adjust the cable length between the HMD and the auxiliary battery. For example, using the retraction device described herein, the cable can have a length between 50 mm and 2 meters. As used herein, the “length” of the cable can refer to cable that is uncollected (e.g., cable that is external to a housing in which the collected cable is stored). In some examples, the length of uncollected cable, when pulled taught, can be approximately equal to a distance separating the HMD and the auxiliary battery.

The assembly can include a retraction device to adjust a length of the cable extending between the HMD and an accessory (such as an auxiliary power supply). The retraction device can be location in a number of locations within the assembly. For example, the retraction device can be integrated into the display unit or housing of the HMD or can be integrated into a retention band or support arms holding the HMD to the user's head. As described below, the retraction device can be integrated into an auxiliary power unit. In some examples, the retraction device can be independent and physically separate from both the HMD and the accessory. For example, the retraction device can be attached to a segment of cable, positioned between the HMD and the accessory.

In some examples, the accessory can include a housing. The housing can define an internal volume. A battery, such as the auxiliary battery for the HMD, can be disposed within the housing. The retraction device or cable management system can also be disposed within the housing of the accessory. In some examples, the battery can be removable from the housing.

In some examples, the retraction member can include a resilient device, such as a spring, capable of exerting a tension or force on the cable. The spring can exert a constant or dynamic force of the cable. The spring can be directly or indirectly attached to the cable to retract, reel, or spool the cable. The spring can be biased to pull against a direction of extension of the cable. Thus, the cable can be biased toward a contracted state, but can be extended or withdrawn when needed. The cable can be removably or permanently connected to the retraction device. In some examples, the spring can be a torsion spring. In some examples, the spring is a wound spring. The spring, therefore, can provide a constant pull on the cable.

The retraction device can provide a variable retraction force on the cable. For example, the further out the cable is extended, the stronger the retraction force. Alternatively, the retraction device can be designed to provide less retraction force the further apart the HMD is from the power unit.

As described herein, the accessory can include a motor to actuate the retraction device. The motor can be powered by the battery to actuate the retraction device. In some examples, a processor can provide instructions to operate the motor based on an activity of the display unit. In other words, the retraction device can be operated based on applications active on the HMD. In some examples, the motor automatically retracts the cable in response to predetermined inputs. The motor can operate in response to instructions provided by the user via the user interface of the HMD.

The retraction device can include a reel or a spool rotatable to collect the cable. For example, the cable can be wound around the spool. The spool can be controlled manually or via motor. The motor can rotate the spool clockwise or counterclockwise to collect or release the cable. The spool can be a number of shapes and sizes based on the needs of the assembly. The spool can be shaped such that the collected cable is circular, oval, any number of multi-faced shapes (e.g., triangular, rectangular, etc.). The spool can be positioned either internally or externally.

The accessory can include a power unit having a housing and a supplemental battery disposed within the housing. The retraction device can also be disposed within the housing of the power unit. Further, as the cable is collected by the retraction device, the gathered cable (wound or otherwise) can be stored within the housing. In other examples, the cable can be wound and stored on an exterior of the housing.

In some examples, the retraction device can produce a pull force of between approximately 30 grams to approximately 300 grams on the cable. The pull force can be the combined or individual pull forces of the spring and/or motor.

In some examples, an assembly for an HMD can include a display unit, a power unit, a cable configured to establish an electrical connection between the HMD and the power unit, and a retraction device to collect the cable. The display unit can include a user interface to control the retraction device.

The assembly can include a processor to control the retraction device based on one or more sensors that monitor a state of the assembly. For example, the sensors can determine a length of the cable existing between the HMD and the accessory. The sensors can determine a distance separating the HMD and the accessory.

The sensors can determine a physical state of the cable, such as how much slack is in the line and/or if the cable is tangled. For example, a sensor may determine that there is slack beyond a predetermined amount and may prompt the retraction device to shorten the cable length. The sensors can include an encoder capable of determining a distance between the HMD and the accessory. In some examples, the sensors can detect a drop event and can retract the cable in order to slow a decent of the HMD or accessory to minimize impact damage. In some examples, the sensors can detect audio or visual inputs. For examples, the sensor can receive audio or visual commands from the user to adjust the cable.

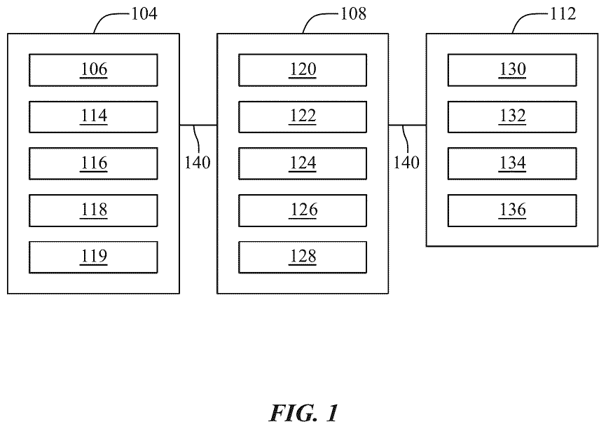

These and other embodiments are discussed below with reference to FIGS. 1-9. However, those skilled in the art will readily appreciate that the detailed description given herein with respect to these figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1 shows a schematic block diagram of an HMD assembly 100. The assembly 100 can include a head-mountable device (HMD 104), a retraction device 108, and an accessory 112. In some examples, the assembly 100 can be modular (i.e., the HMD 104, the retraction device 108, and the accessory 112 can be detachable and separable from one another). In some examples, the HMD 104, the retraction device 108, and the accessory 112 can be in electrical communication via a wire or cable 140.

It will be understood that only select components are shown and described in FIG. 1 for simplicity. The assembly 100 is not limited to these components and may include additional components not shown or described herein.

The HMD 104 can include a power source, such as a primary battery 106, a communications unit 114, one or more sensors 116, a user interface 118, and an attachment interface 119. The primary battery 106 can be a main power source of the HMD 104 and can be operative to electrically couple with and supply power to the components of the HMD 104, the retraction device 108, and/or the accessory 112. The primary battery 106 can be a rechargeable battery, such as a lithium-ion polymer battery. The primary battery 106 can be completely housed within a housing of the HMD 104. Although FIG. 1 shows the primary battery 106 as a single unit, multiple batteries can serve as the main power source of the HMD 104.

The HMD 104 can include a communications unit 114 to communicate with one or more electronic devices, such as the retraction device 108 and/or the accessory 112. The communications unit 114 can establish a link to a communications unit 130 of the accessory 112. The communications link can be a physical connection, such as an electrical wire or cable 140, or can be a wireless connection, such as Bluetooth, Wi-Fi, proximity sensors, etc.

The sensor unit 116 can detect or determine one or more aspects of the operational environment or physical environment of the assembly 100. Although only one sensor unit 116 is shown on the HMD 104 of FIG. 1, it will be understood that the sensor unit 116 can include multiple physically distinct or combined sensors that are included on the HMD 104. For example, sensor unit 116 can include one or more of an encoder, a contact sensor, a pressure sensor, a proximity sensor, a camera, a microphone, an infrared receiver, a global positioning system unit, a gyroscopic sensor, an accelerometer, a capacitive sensor, a biometric sensor, a magnetometer, a radar unit, a LIDAR unit, an ultrasound unit, a temperature sensor, or any other sensor capable of detecting or determining one or more aspects or conditions of the operational environment of the assembly 100. In a specific example, the sensor unit 116 can determine a state of the cable 140 (e.g., length of cable, slack, amount of cable collected, position of cable, etc.). The sensor unit 116 can be operatively coupled to the retraction device 108 to cause the retraction device 108 to perform one or more actions. For example, upon determining a state of the cable 140, the sensor 116 can produce a signal that triggers an action by the retraction device to shorten or lengthen the cable 140.

The attachment interface 119 (also referred to as a headband, support arms, and retention band) can attach or couple with the HMD 104. In some examples, the attachment interface 119 is a band, strap, belt, arms, or other form of support that secures the HMD 104 to a user's head.

The assembly 100 can include a wire or cable 140 for establishing an electrical connection between at least two of the accessory 112, the retraction device 108, and the HMD 104. Specifically, the cable 140 can establish electrical communication with the primary battery 106 of the HMD 104 and a power source 136 of the accessory 112. Power and/or data can be transferred between the accessory 112 and the HMD 104. For example, power can be transferred from the power source 136 of the accessory to charge the primary battery 106 of the HMD 104. The cable 140 can also transfer power/data from the HMD 104 to the retraction device 108 and/or the accessory 112. The cable 140 can be removably or permanently connected to the HMD 104, the retraction device 108, and/or the accessory 112.

In some examples, the retraction device 108 (also referred to as a cable manager, cable management system or cable organizer). The retraction device 108 can organize, gather, collect, wind, retain, or otherwise manage the cable 140. The accessory 112 can be in direct electrical communication with the HMD 104 via the cable 140. The length of the cable 140 can be cumbersome, making it difficult to use the HMD 104 while connected to the accessory 112. Thus, the retraction device 108 can be used to orderly and conveniently shorten and store the cable 140 to remove cumbersome slack in the cable 140. Although the present disclosure focuses on applications in the context of a head-mountable display, the retraction devices described herein are not limited to use in the HMD field. For example, the retraction devices described herein can be used in several contexts, such as headphone cables and cables for smart phones and computing device.

In some examples, the retraction device 108 includes a motor 120, such as a servo motor or stepper motor. The motor 120 can actuate or move a component attached to the cable 140 in order to adjust the cable 140. The motor 120 can rotate in a first direction to retract or shorten the cable 140 and can rotate in a second direction to extend or lengthen the cable 140. The motor 120 can be in electrical communication with one or more processors or controllers of the assembly 100. As used herein, parts in “electrical communication” with each other are configured to exchange electrical signals, directly or indirectly, between each other, whether uni-directionally or bi-directionally. For example, an object sensor can be said to be in electrical communication with a processor or controller device if the processor or controller device is using signals generated by the object sensor or if the processor or controller device is using signals reliant upon or derived at least in part on the signals generated by the object sensor.

The motor 120 can be powered by at least one of the primary battery 106 of the HMD 104, the power source 136, of the accessory 112, and a power source on board the retraction device 108. The motor 120 can operate automatically (e.g., based on preprogrammed instructions) and/or can be operated/controlled by the user (e.g., via user input at the user interface 118 of the HMD 104).

As described in greater detail with reference to FIG. 8, the retraction device 108 can include a lock 122 for securing the cable 140 in a desired position. The lock 122 can be manually or automatically engaged. As discussed, the retraction device 108 can provide a constant pull on the cable 140, which can be interrupted by the lock 122, allowing the user to set the cable 140 at a desired length.

In some examples, the retraction member 108 can include a resilient device, such as a spring 124, capable of exerting a constant tension or force on the cable 140. The spring 124 can be directly or indirectly attached to the cable 140 to retract, reel, or spool the cable 140. The spring 124 can be biased to pull against a direction of extension of the cable 140. Thus, the cable 140 can be biased toward a contracted state but can be extended or withdrawn when needed. The cable 140 can be removably or permanently connected to the retraction device 108.

In some examples, the retraction device 108 can include a sensor unit 126. The sensor unit 126 can detect or determine one or more aspects of the operational environment or physical environment of the assembly 100. Although only one sensor unit 126 is shown in FIG. 1, it will be understood that the sensor unit 126 can include multiple physically distinct or combined sensors. For example, sensor unit 126 can include one or more of an encoder, a contact sensor, a pressure sensor, a proximity sensor, a camera, a microphone, an infrared receiver, a global positioning system unit, a gyroscopic sensor, an accelerometer, a capacitive sensor, a biometric sensor, a magnetometer, a radar unit, a LIDAR unit, an ultrasound unit, a temperature sensor, or any other sensor capable of detecting or determining one or more aspects or conditions of the operational environment of the assembly 100. In a specific example, the sensor unit 126 can determine a state of the cable 140 (e.g., length of cable, slack, amount of cable collected, position of cable, etc.). The sensor unit 126 can be operatively coupled to the retraction device 108 to cause the retraction device 108 to perform one or more actions. For example, upon determining a state of the cable 140, the sensor 126 can produce a signal that triggers an action by the retraction device, such as triggering the motor 120 to shorten or lengthen the cable 140.

The retraction device 108 can include an actuator input, such as a button 128 to actuate the retraction device (e.g., to actuate the motor 120, the spring 124, and/or the lock 122). The button 128 can be located on the HMD 104 or the accessory 112.

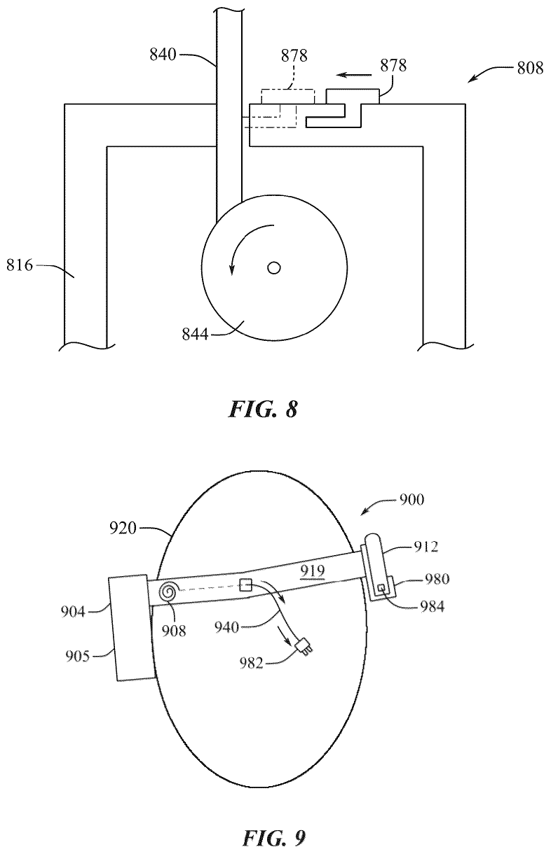

The retraction device 108 can be integrally formed within an interior of the HMD 104 (see, e.g., FIG. 9 and associated discussion). For example, the retraction device 108 can be integrally formed with a housing of the display unit or within the attachment interface 119. Likewise, the cable 140 can be at least partially stored within the attachment interface 119 or a housing of the HMD 104. In some examples, the retraction device 108 is positioned on an exterior of the HMD 104.

The accessory 112 can include a communications unit 130, a sensor unit 132, a user interface 134 and a power source 136. The accessory 112 can be a companion device that communicates with the HMD 104 via a communications link. The communications link can be established between the communications unit 130 of the accessory 112 and the communications unit 114 of the HMD. The communications link can be a physical connection, such as an electrical wire or cable 140, or can be a wireless connection, such as Bluetooth, Wi-Fi, proximity sensors, etc. The accessory 112 can be a battery, remote, or a personal computing device such as a smart phone, a smart watch, a tablet, or any other form of electronic device. The accessory 112 can be a primary or main battery to power the HMD 104.

In some examples, the accessory 112 can include a sensor unit 132. The sensor unit 132 can detect or determine one or more aspects of the operational environment or physical environment of the assembly 100. Although only one sensor unit 132 is shown in the accessory 112, it will be understood that the sensor unit 132 can include multiple physically distinct or combined sensors. For example, sensor unit 132 can include one or more of an encoder, a contact sensor, a pressure sensor, a proximity sensor, a camera, a microphone, an infrared receiver, a global positioning system unit, a gyroscopic sensor, an accelerometer, a capacitive sensor, a biometric sensor. a magnetometer, a radar unit, a LIDAR unit, an ultrasound unit, a temperature sensor, or any other sensor capable of detecting or determining one or more aspects or conditions of the operational environment of the accessory 112. In a specific example, the sensor unit 132 can determine a state of the cable 140 (e.g., length of cable, slack, amount of cable collected, position of cable, etc.). The accessory 112 can include a user interface 134 enabling the user to interact with the accessory 112 by providing inputs or receiving output via the user interface 134.

In some examples, the accessory 112 can include a power source 136 that serves as a supplemental or auxiliary battery. The power source 136 can be a rechargeable battery, such as lithium-ion polymer battery. The auxiliary battery 112 can provide power to one or more components of the HMD 104. In some examples, the auxiliary battery 136 can be used to charge the primary battery 106. In some examples, the power source 136 can power the retraction device 108. In some examples, the primary battery 106 can power the retraction device 108.

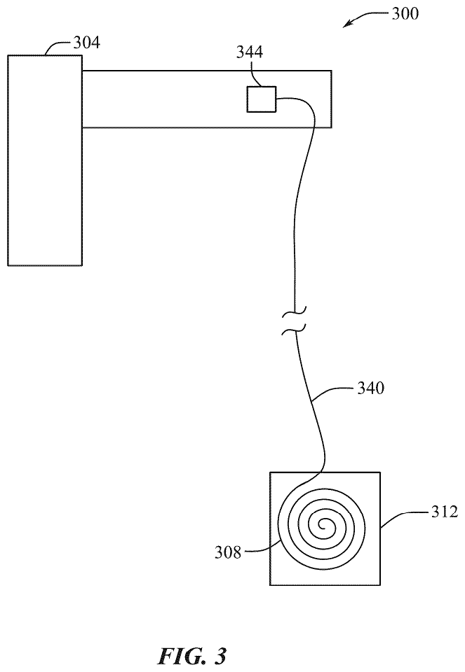

The retraction device 108 can be integrally formed within an interior of the accessory 112 (see, e.g., FIGS. 3-6 and associated discussions). For example, the retraction device 108 can be integrally formed with a housing of the accessory 112. Likewise, the cable 140 can be at least partially stored within the accessory 112. In some examples, the retraction device 108 is positioned on an exterior of the accessory 112. The retraction device 108 can be positioned at strategic locations along the cable 140. For example, the retraction device 108 can include a housing that is clipped or attached to the user's clothing. In some examples, the retraction device 108 is operably attached to the cable at a position between the HMD 104 and the accessory 112.

Any of the features, components, and/or parts, including the arrangements and configurations thereof shown in FIG. 1 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 1. Further, for simplicity, reference numbers ending in like or similar numbers, but with changes in the hundreds place may refer to the same or similar component from a different embodiment or figure. For example, HMD 104 and HMD 204 may share many of the same characteristics and components, while remaining distinct embodiments.

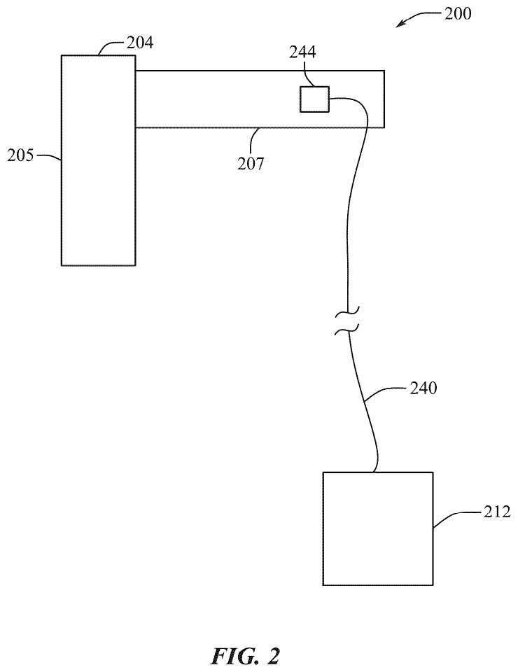

FIG. 2 shows a side view of an HMD assembly 200. The assembly 200 can be substantially similar to, including some or all of the features of the assemblies described herein, such as assembly 100. The assembly 200 can include a display unit 205, a user attachment interface 207 having an auxiliary battery 212. As described herein, given the power needs of head-mountable displays and current battery technology, it is desirable for a head-mountable assembly including an auxiliary or supplementary battery that can supplement a primary battery of the device. Thus, the assembly 200 can include an auxiliary battery 212 electrically connected to the HMD 204 via a cable 240. A first end of the cable can be connected to the auxiliary battery and a second end of the cable 240 can be connected to an electrical connector 244 on the HMD 204 (e.g., on a retention band 207 or on the display unit 205). The inclusion of the auxiliary battery 212 connected using the cable 240 creates a challenge of cable management.

Any of the features, components, and/or parts, including the arrangements and configurations thereof shown in FIG. 2 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 2.

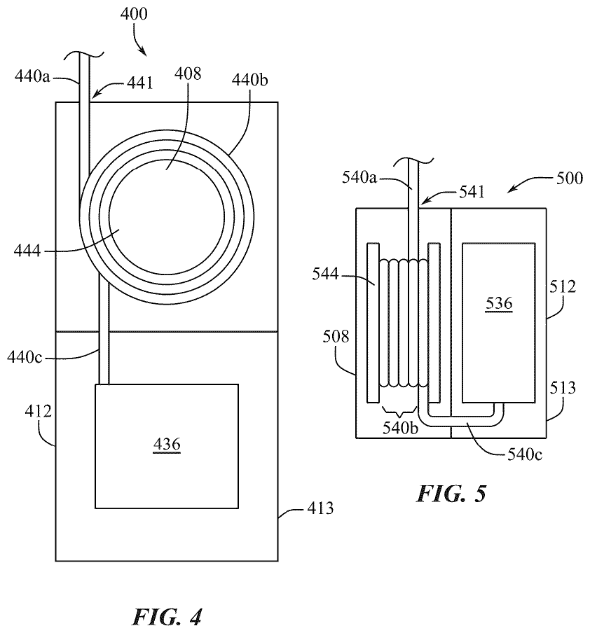

FIG. 3 shows a side view of an HMD assembly 300. The assembly 300 can be substantially similar to, including some or all of the features of the HMD assemblies described herein, such as assembly 100 and 200. As described, the inclusion of an auxiliary battery 312 connected using the cable 340 creates a challenge of challenge of cable management. As a solution to this challenge, the assembly 300 can include a retraction device 308 that is integrated into or onto the auxiliary battery 312. Further details of a retraction device integrated with an auxiliary battery is described in FIGS. 4-6.

Any of the features, components, and/or parts, including the arrangements and configurations thereof shown in FIG. 3 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 3.

FIG. 4 shows a cross-sectional view of an assembly 400. The assembly 400 can be substantially similar to, including some or all of the features of the assemblies described herein, such as assembly 100-300. The assembly 400 can include an accessory 412 that includes a housing 413 that houses or contains a power source 436 and a retraction device 408. In other words, the retraction device 408 and the power source 436 can both be housed by the housing 413 of the accessory 412.

The housing 413 of the accessory 412 can define an opening 441 that allows a first segment of cable 440a to enter the internal volume defined by the housing 413. A second segment of cable 440b can be disposed within the housing 413 and can be would around a reel or spool 444. A third segment of cable 440c can extend between the spool 444 and the power source 436.

In some examples, the retraction device 408 and the power source 436 are vertically oriented or stacked, sharing a common vertical axis. In some examples, the retraction device 408 and the power source 436 are disposed in a single compartment of the housing 413. In some examples, the retraction device 408 and the power source 436 are each contained in separate, isolated compartments of the housing 413. In some examples, a direct electrical connection is established between the compartment holding the retraction device 408 and the compartment holding the battery 436. In other words, the third segment of cable 440 may not pass into the battery compartment, but instead connect to an electrical interface in the compartment holding the retraction device.

In some examples, the retraction device 408 and the power source 436 are modular components, capable of being separated and reattached. In some examples, the retraction device 408 and the power source 436 are permanently fixed together (e.g., forming a unitary component).

Any of the features, components, and/or parts, including the arrangements and configurations thereof shown in FIG. 4 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 4.

FIG. 5 shows a cross-sectional view of an assembly 500. The assembly 500 can be substantially similar to, including some or all of the features of the assemblies described herein, such as assembly 100-400. The assembly 500 can include an accessory 512 that includes a housing 513 that houses or contains a power source 536 and a retraction device 508. In other words, the retraction device 508 and the power source 536 can both be housed by the housing 513 of the accessory 512.

The housing 513 of the accessory 512 can define an opening 541 that allows a first segment of cable 540a to enter the internal volume defined by the housing 513. A second segment of cable 540b can be disposed within the housing 513 and can be would around a reel or spool 544. A third segment of cable 540c can extend between the spool 544 and the power source 536.

In some examples, the retraction device 508 and the power source 536 are horizontally oriented, side by side, sharing a horizontal axis. A major surface of the retraction device 508 can be parallel to a major surface of the power source 536. In some examples, the retraction device 508 and the power source 536 are disposed in a single compartment of the housing 513. In some examples, the retraction device 508 and the power source 536 are each contained in separate, isolated compartments of the housing 513. In some examples, a direct electrical connection is established between the compartment holding the retraction device 508 and the compartment holding the battery 536. In other words, the third segment of cable 540 may not pass into the battery compartment, but instead connect to an electrical interface in the compartment holding the retraction device.

In some examples, the retraction device 508 and the power source 536 are modular components, capable of being separated and reattached. In some examples, the retraction device 508 and the power source 536 are permanently fixed together (e.g., forming a unitary component).

Any of the features, components, and/or parts, including the arrangements and configurations thereof shown in FIG. 5 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 5.

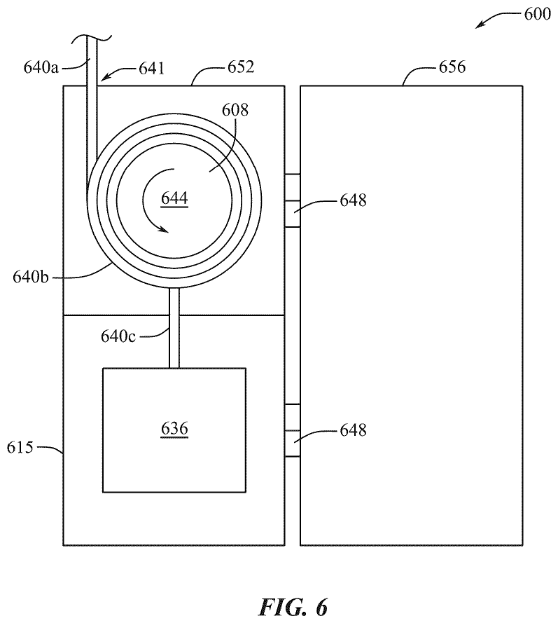

FIG. 6 shows a front view of an assembly 600. The assembly 600 can be substantially similar to, including some or all of the features of the assemblies described herein, such as assembly 100-500. In some examples, the assembly 600 can include a case 615. In some examples, the retraction device 608 is integrated into the case 615, while the power source 636 is removable. In this manner, the case 615 can be an aftermarket accessory that a user can purchase for cable management of the power source 636.

The case 615 can define a volume to house a retraction device 608 and a power source 636. The case 615 can include a movable cover or lid 656 that is articulable via one or more hinges 648. The lid 656 can be opening to access the internal volume of the case 615. The lid 656 can be shut to seal the contents of the case 615 (e.g., the retraction device 608 and the power source 636).

The case 615 can define an opening 641 that allows a first segment of cable 640a to enter the internal volume defined by the case 615. A second segment of cable 640b can be disposed within the case 615 and can be would around a reel or spool 644. A third segment of cable 640c can extend between the spool 644 and the power source 636.

In some examples, the retraction device 608 and the power source 636 are disposed in a single compartment of the case 615. In some examples, the retraction device 608 and the power source 636 are each contained in separate, isolated compartments of the case 615. In some examples, a direct electrical connection is established between the compartment holding the retraction device 608 and the compartment holding the battery 636. In other words, the third segment of cable 640 may not pass into the battery compartment, but instead connect to an electrical interface in the compartment holding the retraction device.

In some examples, the retraction device 608 and the power source 636 are modular components, capable of being separated and reattached. In some examples, the retraction device 608 and the power source 636 are permanently fixed together (e.g., forming a unitary component).

Any of the features, components, and/or parts, including the arrangements and configurations thereof shown in FIG. 6 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 6.

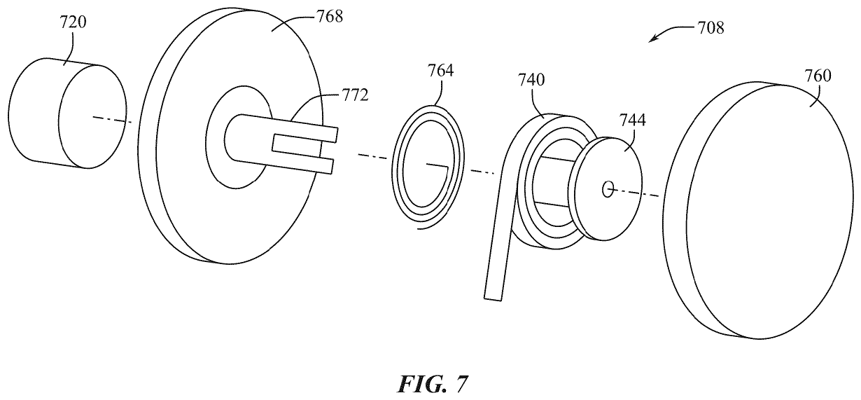

FIG. 7 shows an exploded view of an example retraction device 708. The retraction device 708 can be substantially similar to, including some or all of the features of the retraction devices described herein, such as retraction devices 108-608. It will be understood that only select components are shown and described in FIG. 7 for simplicity.

The retraction device 708 is not limited to these components and may include additional components not shown or described herein.

The retraction device 708 can include a cover 760, a spool 744 about which a cable 740 can be wound. In some examples, the cable 740 can be a thin, flat shaped cable to decrease the space required to house the wound cable 740.

The retraction device 708 can include a spring 764 that is connected to the spool 744 and to a fixed post 772. The fixed post 772 can extend from a base 768. The fixed, static nature of the post 772 allows the spring 764 to build tension as the spool 744 is rotated. In some examples, the retraction device 708 includes a motor 720. It will be understood that the spring 764 may not be included in the retraction device 708 when the motor 720 is present and cable of rotating the spool 744. In some examples, the spring 764 and the motor 720 work in combination to adjust the length of the cable 740.

The motor 720 can be any suitable motor, such as a servo motor or stepper motor. The motor 720 can actuate or move the fixed post 772 and/or the spool 744 in order to adjust the cable 740. The motor 720 can rotate the spool clockwise to retract or shorten the cable 740 and can rotate the spool 744 counter-clockwise to extend or lengthen the cable 740. The motor 720 can be in electrical communication with one or more processors or controllers of the assembly. The motor 720 can be powered by at least one of the primary battery of the HMD, the power source of the accessory, and a power source on board the retraction device 708. The motor 720 can operate automatically (e.g., based on preprogrammed instructions) and/or can be operated/controlled by the user (e.g., via user input at a user interface of the HMD).

Any of the features, components, and/or parts, including the arrangements and configurations thereof shown in FIG. 7 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 7.

FIG. 8 shows a cross-sectional view of a retraction device 808. The retraction device 808 can be substantially similar to, including some or all of the features of the retraction devices described herein, such as retraction devices 108-708. In some examples, the retraction device 808 can include a locking mechanism 878. The locking mechanism 878 can secure the cable 840 in a desired position. The locking mechanism 878 can be manually or automatically engaged. For example, the locking mechanism 878 can include a sliding tab movable by the user.

In a first position (shown in solid lines), the locking mechanism 878 does not contact the cable 840, allowing for free motion of the cable 840. In a second position (shown in dashed lines), the locking mechanism 878 can contact the cable 840, preventing free motion of the cable 840. In the specific example shown in FIG. 8, the locking mechanism 878 slides to pinch the cable 840 against a housing 816 of the retraction device 808. It will be understood that other suitable locking mechanism can be utilized for limiting motion of the cable 840. For example, a locking mechanism can be incorporated into the spool 844 itself. As discussed, the retraction device 808 can provide a constant pull on the cable 840, which can be interrupted by the locking mechanism 878 allowing the user to set the cable 840 at a desired length.

The retraction device 808 can include an actuator input, such as a button to actuate the retraction device (e.g., to actuate a motor, a spring, and/or the locking mechanism 878). The button can be located on the HMD or the accessory. In some examples, the locking mechanism 878 can include a solenoid.

Any of the features, components, and/or parts, including the arrangements and configurations thereof shown in FIG. 8 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 8.

FIG. 9 shows a side view of an HMD assembly 900 worn by a user 920. The assembly 900 can be substantially similar to, including some or all of the features of, the assemblies described herein, including assemblies 100-800. The assembly 900 can include an HMD 904 having a display unit 905 and a retention band 919, a mount 980, and an accessory 912.

In some examples, the HMD 904 and/or the retention band 919 can include an integrated cable management system for managing a power cable 940. The cable management system 1017 can include a retraction device 908 that can retract, reel, or spool the cable 940. The retraction device 908 can be a spring biased to pull against a direction of extension of the cable 940. Thus, the cable 940 can be biased to a contracted state but can be extended or withdrawn in order to connect to the accessory 912. For example, the cable 1024 can include an electrical connector 982 that can establish an electrical connection with a connector 984 of the accessory 912. Thus, the cable 940 can establish an electrical connection between the HMD 904 and the accessory 912. The cable 940 can be removably or permanently connected to the HMD 904.

The retraction device 908 can be integrally formed within an interior of the retention band 919. Likewise, the cable 940 can be at least partially stored within the retention band 919. In some examples, the retraction device 908 is positioned within an internal volume of a housing of the display unit 905. In some examples, the retraction device 908 is positioned on an exterior of the HMD 904 and/or the retention band 919.

The retraction device 908 can be operated either manually or automatically. In some examples a manual control member, such as a knob, button, or dial can be actuating by the user 920 to operate the retraction device 908. The manual control member can be accessible on an exterior of the display unit 905 and/or the retention band 919.

The mount 980 can be attached to the retention band 919 (e.g., opposite the display unit 905). The mount can securely and conveniently hold the accessory 912 close to the HMD 904, allowing the cable 940 to shorten to a minimal and unobtrusive length.

Any of the features, components, and/or parts, including the arrangements and configurations thereof shown in FIG. 9 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 9.

It should be understood that personally identifiable information ccan be used by the present system in some examples, and that the use of personally identifiable information should follow generally recognized privacy policies and practices that meet or exceed governmental or industry requirements for ensuring the privacy of users. More specifically, personally identifiable information data should be secured so as to minimize risks of unauthorized access or use, with the nature of authorized use being clearly indicated to users.

The foregoing description, includes a number of specific details that are not required in order to practice the described embodiments. Rather, the foregoing descriptions of the specific embodiments described herein are presented for purposes of illustration and description. They are not intended to be exhaustive or to limit the embodiments to the precise forms disclosed. It will be apparent to one of ordinary skill in the art that many modifications and variations are possible in view of the above teachings.

What is claimed is:

1. A head-mountable device assembly, comprising:
a display;
a power unit;
a cable electrically connecting the display and the power unit; and
a retraction device configured to collect the cable.

2. The assembly of claim 1, wherein:
the power unit comprises a housing and a battery;
the retraction device is disposed within the housing; and
the cable is collectable within the housing.

3. The assembly of claim 1, wherein the retraction device comprises a torsion spring.

4. The assembly of claim 1, wherein the retraction device comprises a cable lock.

5. The assembly of claim 1, wherein the retraction device comprises a motor that actuates the retraction device in response to an input.

6. The assembly of claim 1, further comprising:
a sensor; and
a processor configured to actuate the retraction device in response to a signal from the sensor.

7. The assembly of claim 1, further comprising a processor configured to operate the retraction device based on an activity of the display.

8. The assembly of claim 1, wherein the display comprises a user interface to control the retraction device.

9. The assembly of claim 1, further comprising an encoder to determine an uncollected length of the cable.

10. The assembly of claim 1, wherein the retraction device is integrated into the power unit.

11. An electronic accessory for a head-mountable device, comprising:
a housing;
a battery disposed within the housing; and
a cable retraction system disposed within the housing.

12. The electronic accessory of claim 11, wherein the battery is removable from the housing.

13. The electronic accessory of claim 11, the cable retraction system comprising:
a motor electrically connected to the battery; and
a spool connected to the motor and the cable.

14. The electronic accessory of claim 11, wherein the cable has a length between 50 mm and 2 meters.

15. The electronic accessory of claim 11, wherein the retraction device imparts a pull force of between approximately 30 grams to approximately 300 grams on the cable.

16. A head-mountable device (HMD), comprising:
a display;
a cable electrically connectable to the head-mountable device and to a battery; and
a retraction device configured to collect the cable, the retraction device comprising:
a spool rotatable to collect the cable;
a motor configured to rotate the spool; and
a processor configured to operate the motor based on an activity of the display.

17. The HMD of claims 16, wherein the retraction device retracts the cable in response to detecting slack in the cable.

18. The HMD of claims 16, wherein the retraction device provides a constant pull force on the cable.

19. The HMD of claims 16, wherein the retraction device comprises a torsion spring.

20. The HMD of claims 16, further comprising an encoder to determine an uncollected length of the cable.
